(19) United States
(12) Patent Application Publication
(10) Pub. No.: US 2013/0313091 A1
(43) Pub. Date: Nov. 28, 2013

(54) Operating Mechanism for Circuit Breaker

(71) Applicants: Sujit S. Patwardhan, Mumbai (IN); Rubin Cholera, Mumbai (IN); Yogesh N. Patil, Mumbai (IN); Arvind L. Kumar, Mumbai (IN); N. Prabhu, Mumbai (IN)

(72) Inventors: Sujit S. Patwardhan, Mumbai (IN); Rubin Cholera, Mumbai (IN); Yogesh N. Patil, Mumbai (IN); Arvind L. Kumar, Mumbai (IN); N. Prabhu, Mumbai (IN)

(73) Assignee: LARSEN & TOUBRO LIMITED, Mumbai (IN)

(21) Appl. No.: 13/983,184

(22) PCT Filed: Jul. 28, 2011
(86) PCT No.: PCT/IB2011/001744

§ 371 Date: Aug. 1, 2013

(30) Foreign Application Priority Data
Mar. 1, 2011 (IN) 582/MUM/2011

(51) Int. Cl. H01H 3/38

(52) U.S. Cl. CPC H01H 3/38
USPC 200/325

(57) ABSTRACT

An improved operating mechanism of a molded case circuit breaker comprises a housing, a fixed contact means, a moving contact means, a rotor means, and a mechanism module. The mechanism module comprises side plate means, trip plate means, a lower link means, an upper link means, a latch link means, a fork link means, a spring pin means, a floating pin means, navigation pin means, reset roller pin means and plurality of spring means.

### FIELD OF THE INVENTION

The present invention relates to a molded case circuit breaker. More particularly, the invention is concerned about an improved operating mechanism of molded case circuit breaker which enables it to make, carry and break current under normal circuit condition and also break during abnormal conditions.

### BACKGROUND OF THE INVENTION

Circuit breakers are mechanical switching devices capable of making, carrying and breaking currents under normal circuit conditions and also making, carrying for a specified time and breaking currents under specified abnormal conditions. A circuit breaker basically consists of a pair of separable contacts and an interrupting medium. The function of the contacts is to conduct the electrical current when the breaker is closed and to withstand the arcs while interrupting. Generally the electrical contacts have a stationary part and a moving part. By bringing the moving contact to touch the stationary contact, an electric current flows and the breaker is closed. By driving the moving contact away from the stationary contact, an electric arc is developed and by quenching the electrical arc, the flow of electrical current is stopped and the breaker is opened.

U.S. Pat. No. 4,528,531 discloses a molded case circuit breaker includes a highly integrated operating mechanism having an over-center toggle mechanism for opening and closing a pair of electrical contacts and a trip mechanism for responding to overload and short circuit or fault current conditions to separate the pair of electrical contacts. A generally flat, intermediate latch plate includes an upper latch surface for latching with a movable cradle of the over-center toggle mechanism and a lower latch surface for latching with a trip bar of the trip mechanism and a pair of outwardly projecting pivot arms disposed between the upper and lower latch surfaces. The over-center toggle mechanism includes a pair of upper toggle links and a pair of lower toggle links interconnected by a toggle spring pin. To increase the speed of separation of the first and second electrical contacts during a trip operation, the cradle is physically configured to engage and upwardly propel the toggle spring pin and, also, the upper toggle links have projections for physically contacting a rigid stop.

U.S. Pat. No. 4,864,263 discloses an industrial rated molded case circuit breaker having an electronic trip circuit contained within the circuit breaker enclosure includes a reset spring in cooperation with the circuit breaker latch spring to insure manual reset of circuit breaker after an automatic trip function. The reset spring allows the circuit breaker latch assembly to be manually reset upon minimum travel of the circuit breaker operating handle due to internal circuit breaker component space restrictions. The circuit breaker latch assembly is robotically loaded to the operating mechanism which is then attached to the circuit breaker case by an automated fastening process.

U.S. Pat. No. 6,479,774 discloses a circuit breaker operating mechanism comprises a movable handle yoke, a mechanism spring extending in tension from the handle yoke to a pin, and a lower link extending from the pin to a crank operably connected to a contact arm bearing a movable contact. The crank is positionable in open and closed positions, being in an open position when the movable contact is separated from an associated fixed contact and being in a closed position when the movable contact is mated to said associated fixed contact. The circuit breaker further comprises an interface formed on said crank and a blocking prop having a first surface that engages said interface, the first surface preventing the crank from rotating towards the closed position

U.S. Pat. No. 6,590,172 discloses a circuit breaker is provided wherein the circuit breaker comprises a contact arm movable between a closed position, an open position and a blown open position wherein the contact arm is disposed in the circuit breaker. A bumper disposed to contact the contact arm when the contact arm is in the blown open position. In addition, a stop member disposed to be in contact with a linkage assembly so as to create a gap between the bumper and the contact arm when the contact arm is disposed in the open position.

U.S. Pat. No. 5,369,384 discloses a breaker mechanism for power circuit breakers is the energy storage link between the handle and the contact systems. Known breaker mechanisms are generally too expensive to manufacture. When contact welding occurs, there is also the risk that, in spite of the tripping of the breaker mechanism, the contact system will not open. The new breaker mechanism reliably opens the contact system and consists of fewer and technologically simpler individual parts. It is inserted between two symmetrical breaker plates held in a die cast housing, and in which a connecting piece is mounted. Two toggle levers are connected at a distance from one another by means of a connecting shaft engaged in crossbar cam slots. A toggle lever spring is engaged between the connecting piece and the connecting shaft. A bracing lever which can be driven by the connecting piece is friction locked in the breaker plates, and the toggle levers in the bracing lever. A latch lever and a latch holding the latter in the locked position are friction locked by means of a latch spring in recesses of the breaker plates.

The disadvantages of the above mentioned patent literature are such that use of upper link, lower link, connection pin as a floating pin limits the moving contact rotation. It also uses latch link as a navigator which again limits the moving contact rotation and also increases the latch link rotation required during ON to TRIP. During TRIP to RESET, the above mentioned patent literatures use the pin attached to the fork link and cam action between pin and latch link which results in high reset force due to action of static friction instead of rolling friction. Also extra pin is required to act as a stopper for latch link during ON to TRIP operation.

Thus, there is a need to overcome the problems of the prior art. Therefore, present inventors have developed an improved operating mechanism of molded case circuit breaker that would enable high rotation of the contact link, reduction of reset force required, better performance, less number of components and better ergonomic considerations.

### OBJECTS OF THE INVENTION

An object of the present invention is to overcome the problems/disadvantages of the prior art.

Another object of the present invention is to provide an improved operating mechanism of molded case circuit breaker.

These and advantages of the present invention will become readily apparent from the following detailed description taken in conjunction with the accompanying drawings.

### SUMMARY OF THE INVENTION

According to one aspect of the present invention there is provided an improved operating mechanism of molded case circuit breaker, said mechanism comprising:
a housing;
a fixed contact means;
a moving contact means;
a rotor means;
a mechanism module comprising:
plurality of plate means comprising at least one side plate profile means wherein said side plate profile means comprising plurality of predetermined sized slot means operatively located on said side plate means and a top surface of said plate profile comprises uneven surface having a cam profile;
plurality of link means comprising a lower link means, an upper link means, a latch link means, a fork link means;
wherein said upper link means and said lower link means being pivotally connected to each other and said lower link means being operatively connected between said upper link means and said rotor means;
wherein said latch link profile means being operatively connected to said upper link means and said latch link profile comprising a substantially ‘sickle’ shaped profile wherein a substantially ‘hook’ shaped bend portion of latch link means operatively engaged with said slot means of said side plate means so as to stop rotation of said latch link means during ON to TRIP positions;
wherein said fork link profile means comprising a substantially ‘U’ shaped profile wherein an optimized size of cam profile adapted to reduce force required during TRIP to RESET operation; wherein a bended portion of said fork link means operatively engaged with said side plate means such that said side plate means stops rotation of said fork link means during extreme ON and OFF position;
plurality of pin means comprising a spring pin means, a floating pin means, navigation pin means, reset roller pin means;
wherein said floating pin means operatively connected to said upper link means so as to enabling high rotation of said moving contact means;
wherein said navigation pin means being navigated by means of cam profile of said side plate means between said side plate means and said navigation pin means so as to enable higher rotation of said moving contact means with less rotation of said latch link means;
wherein said reset roller pin means being operatively connected to said latch link means so as to reduce reset force;
wherein said spring pin means being operatively inserted in the fork link means in a manner that plurality of spring means operatively connected between said spring pin means and said floating pin means.

### BRIEF DESCRIPTION OF THE ACCOMPANYING DRAWINGS

Other features as well as the advantages of the invention will be clear from the following description.

In the appended drawings:

FIG. 1 illustrates Isometric view of the 3 pole Circuit Breaker cassette with breaker is in ON condition

FIG. 2 illustrates Isometric view of the single pole Circuit Breaker cassette with breaker is in ON condition

FIG. 3 illustrates Isometric view of Mechanism in ON condition with breaker cassette hidden

FIG. 4 illustrates sectional view of Mechanism in ON position.

FIG. 5 illustrates sectional view of Mechanism in OFF position.

FIG. 6 illustrates sectional view of Mechanism in TRIP condition.

FIG. 7 illustrates Mechanism in ON condition.

FIG. 9 illustrates Mechanism in TRIP position.

FIG. 10 illustrates Mechanism in Reset position.

FIG. 11 illustrates exploded view of the mechanism in ON position.

### DETAILED DESCRIPTION OF THE ACCOMPANYING DRAWINGS

In the following detailed description, reference is made to the accompanying drawings that form a part hereof, and illustrate the best mode presently contemplated for carrying out the invention. Further functioning of the mechanism has been discussed below to describe the way the mechanism operates. However, such description should not be considered as any limitation of scope of the present unit. The structure thus conceived is susceptible of numerous modifications and variations, all the details may furthermore be replaced with elements having technical equivalence. In practice the materials and dimensions may be any according to the requirements, which will still be comprised within its true spirit.

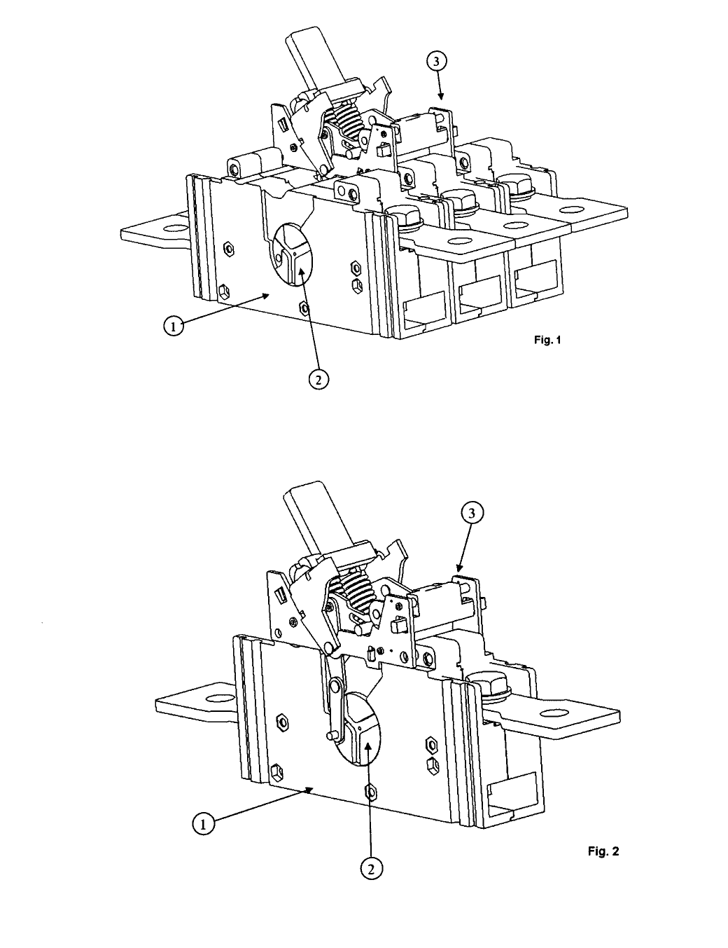

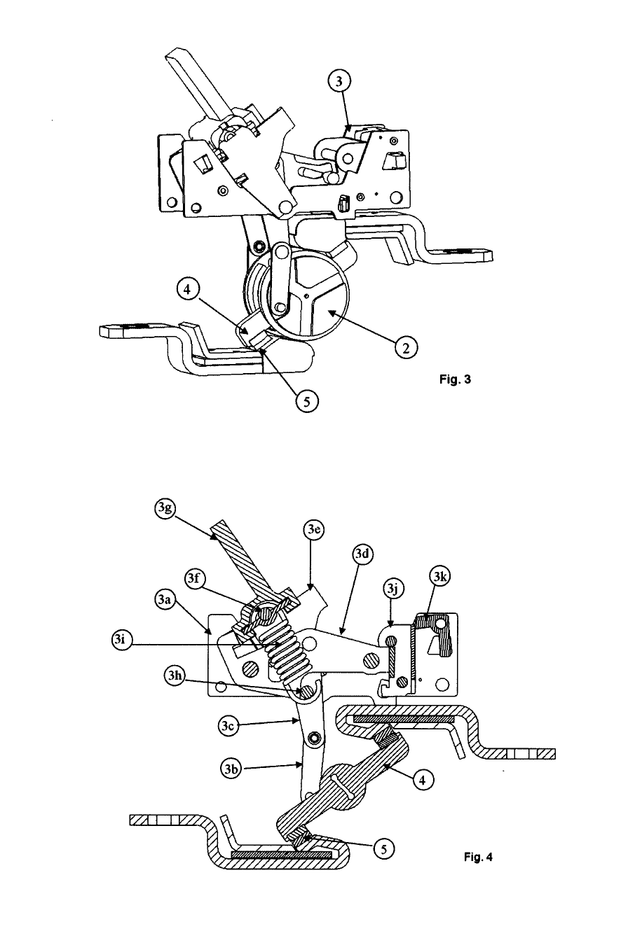

According to the invention there is provided an improved operating mechanism of molded case circuit breaker. FIG. 1 shows an isometric view of the 3 pole Circuit Breaker cassette with breaker is in ON condition. Circuit breaker cassette is a cassette on which circuit breaker mechanism module is mounted. FIG. 2 shows an isometric view of the single pole Circuit Breaker cassette with breaker is in ON condition. FIG. 3 shows an isometric view of mechanism in ON condition with breaker cassette hidden. Circuit breaker mechanism module (3) consists of upper link (3c), lower link (3b), latch link (3d), fork link (3e). A spring pin (3f) is connected to the fork link (3e) and floating pin (3h) is connected to the upper link (3c). Extension spring is connected between spring pin (3f) and floating pin (3h). Knob (3g) connected to the fork link (3e) through which user gives the input. Lower link (3b) is connected to the rotor (2) to which moving contact (4) is attached. During OFF-ON and ON-OFF operation latch link (3d) is locked by latch bracket (3j).

During normal ON-OFF and OFF-ON operation, input to mechanism is given through the rotation of knob (3g) by manual means. The rotation of knob (3g) leads to storing potential energy (spring charging) in the spring member (3i) while restricting the contact movement during the charging operation. At a specified instance the potential energy of spring is released in form of Kinetic energy through Mechanical Linkages leading rotation of the contacts at high velocity. Circuit breaker mechanisms use dead centre based Extension spring arrangements.

FIG. 4 shows the sectional view of the Mechanism which is in ON position. When knob (3g) is rotated by user applied force spring (3i) connected between spring pin (3f) and floating pin (3h) get deflected up to dead centre condition and after the dead centre the stored energy in the spring is converted in to kinetic energy which is used to rotate the moving contact (4) from ON to OFF position through upper link (3c) and lower link (3b).

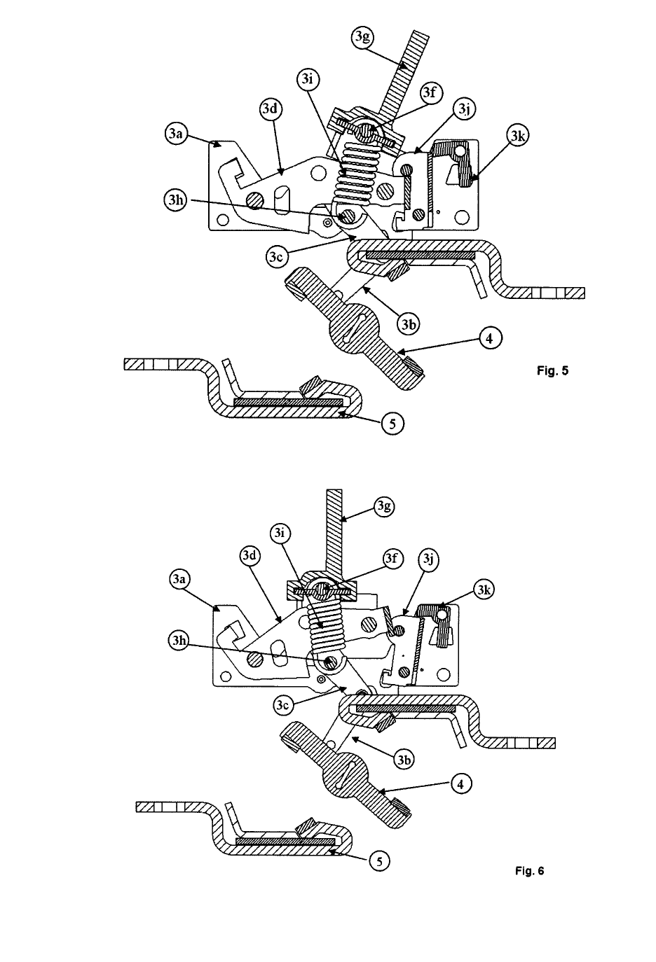

FIG. 5 shows the sectional view of the Mechanism which is in OFF position. When knob (3g) is rotated by user applied force spring (3i) connected between spring pin (3f) and floating pin (3h) get deflected up to dead centre condition and after the dead centre the stored energy in the spring is converted in to kinetic energy which is used to rotate the moving contact (4) from OFF to ON position through upper link (3c) and lower link (3b). Moving contact (4) touch to the fixed contact (5) and breaker gets ON.

FIG. 6 shows the sectional view of the Mechanism which is in TRIP position. When actuation signal is given to the trip plate (3k) it rotates and unlocks the latch bracket (3j) which results in enabling the rotation of latch link (3d). At ON position spring is having stored potential energy which enables the latch link (3d) rotation. Upper link (3c) and lower link (3b) are connected to the latch link (3d) so as rotation of latch link (3d) results in rotation of rotor (2). Moving contact (4) connected to the rotor (2) also rotates and breaker gets disconnected and now in TRIP position.

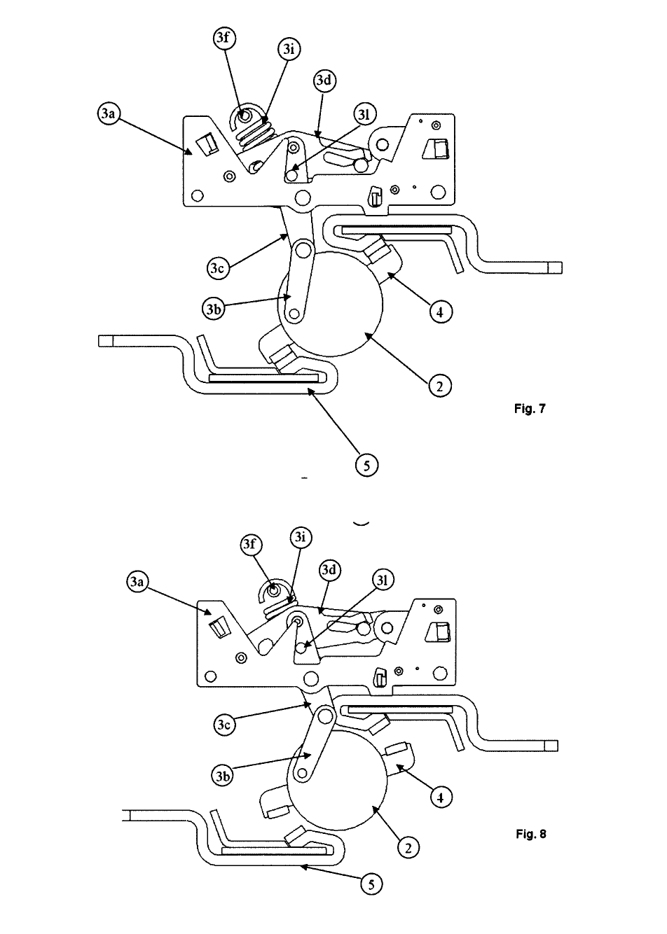

FIG. 7 shows the Mechanism in ON condition. The navigation pin is touched to the side plate (3a). When TRIP signal is given latch link (3d) gets rotated and navigated by the cam connection between side plate (3a) and navigator pin (3l). FIG. 8 shows the intermediate condition from ON to TRIP. This navigation enables the full rotation of moving contact (4) from ON to TRIP position and also helps in less rotation of latch link (3d).

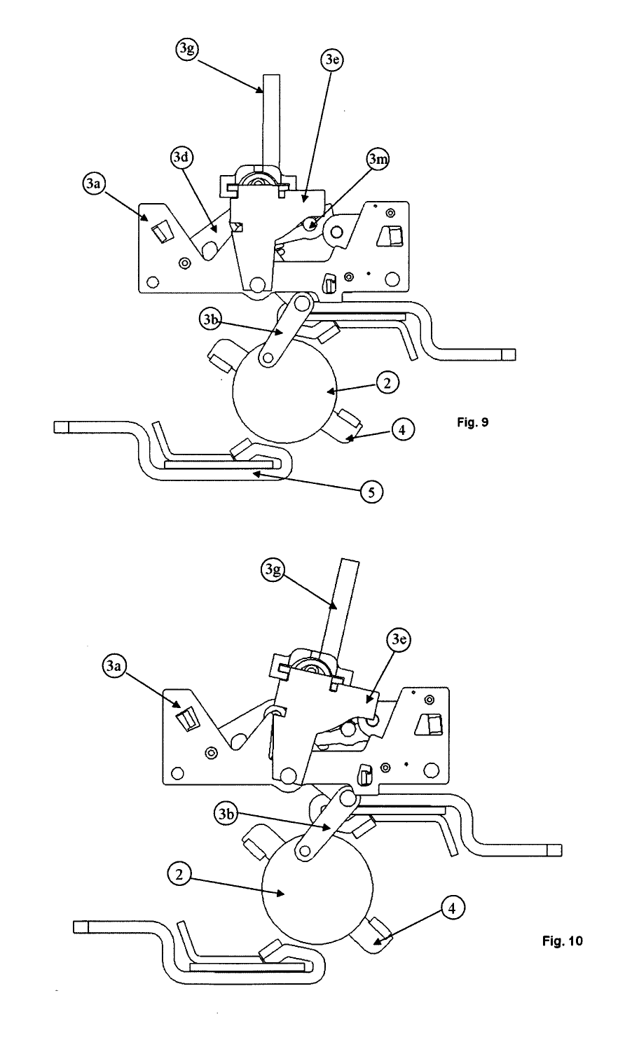

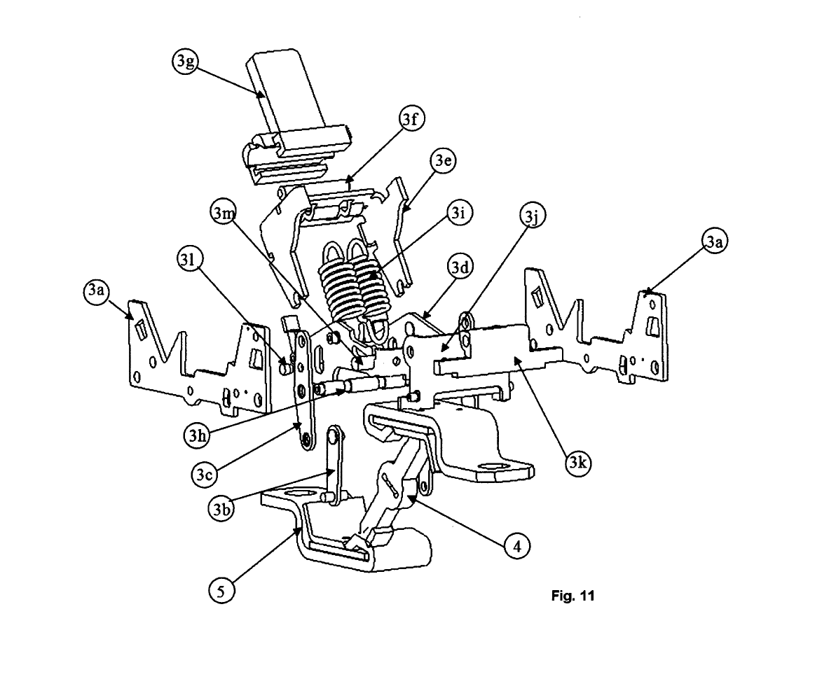

FIG. 9 shows the Mechanism in TRIP position. During TRIP to RESET operation user rotates the knob (3g). At TRIP position fork link (3e) is touched with the reset pin (3m) which is inserted in the latch link (3d). So when force is applied on knob (3g), latch link (3d) is rotated which enables bringing the upper link (3c) & lower link (3b) from TRIP to RESET position. Reset pin (3m) inserted in the latch link (3d) rolls and rolling coefficient of friction between fork link (3e) and reset pin (3m) reduces the reset force. The slots provided on the side plate (3a) acts as a stopper for latch link (3d) rotation. FIG. 10 shows a mechanism in reset position and FIG. 11 shows an exploded view of the mechanism in ON position.

### ADVANTAGES OF THE INVENTION

1. Enabling higher rotation of moving contact.
2. Reducing the reset force required.
3. Less number of components.
4. Better ergonomic considerations.

### Constructional Elements

1: Circuit breaker cassette: It is a cassette on which circuit breaker mechanism module is mounted.
2: Rotor: It is a part which houses moving contact assembly
3: Mechanism module: It consists of various linkages. It is a 4 bar mechanism.
3a: Side plate: It is a part of mechanism module. It guides the handle gear
3b: Lower Link: It is connected between upper link and rotor.
3c: Upper Link: It decides position of dead centre during ON-OFF and OFF-ON operation. One end of it is fixed during ON-OFF and OFF-ON operation and moving during TRIP operation.
3d: Latch Link—It is a link to which upper link is connected. It moves during ON to TRIP condition.
3e: Fork link: It is a link to which mechanism springs are connected.
3f: Spring Pin—Is it inserted in the fork link to which springs are getting connected.
3g: Knob—It is connected to the fork link. User applies the force to knob to operate the circuit breaker.
3h: Floating pin: It is connected to the upper link. One end of the spring is connected to it.
3i: Springs: springs are energy storing elements. One end of which is connected to spring pin and another end is to floating pin.
3j: Latch Bracket: It locks the Latch Link during ON-OFF & OFF-ON operation and unlocks during ON-TRIP operation.
3k: Trip Plate—It locks the Latch Bracket during ON-OFF & OFF-ON operation and unlocks during ON-TRIP operation. It is a part to which TRIP signal is actuated.
3l: Navigation Pin: It is connected to the upper link. It gets navigated by side plate cam during ON to TRIP operation.
3m: Reset Pin: It is connected to the Latch Link. Mechanism get reseted during TRIP to RESET operation by fork link via reset pin.
4: Moving Contact: It is the moving part of the current carrying circuit.
5: Fixed Contact: It is the fixed part of the current carrying circuit.
5: Dead centre—Dead centre is an equilibrium condition of actuating mechanism. In this condition the mechanism spring is fully charged and beyond this point mechanism flips & operates independently due to energy discharged by mechanism spring.

1. An operating mechanism of a molded case circuit breaker, the mechanism comprising:
a housing;
a fixed contact means;
a moving contact means;
a rotor means; and
a mechanism module comprising:
a plurality of plate means comprising at least one side plate profile means wherein said side plate profile means comprises a plurality of predetermined sized slot means operatively located on said side plate means and a top surface of said plate profile comprises an uneven surface having a cam profile ;
a plurality of link means comprising a lower link means, an upper link means, a latch profile link means, and a fork link profile means;
wherein said upper link means and said lower link means are pivotally connected to each other and said lower link means is operatively connected between said upper link means and said rotor means;
wherein said latch link profile means is operatively connected to said upper link means and said latch link profile means comprises a substantially sickle-shaped profile;
wherein a substantially hook-shaped bend portion of the latch link profile means is operatively engaged with said slot means of said side plate means so as to stop rotation of said latch link means during ON to TRIP positions;
wherein said fork link profile means comprises a substantially U-shaped profile;
wherein an optimized size of the cam profile is adapted to reduce force required during TRIP to RESET operation;
wherein a bended portion of said fork link profile means is operatively engaged with said side plate means such that said side plate means stops rotation of said fork link profile during ON and OFF positioning; and
a plurality of pin means comprising a spring pin means, a floating pin means, navigation pin means, and reset roller pin means;
wherein said floating pin means are operatively connected to said upper link means so as to enabling high rotation of said moving contact means;
wherein said navigation pin means are navigated by means of the cam profile of said side plate means between said side plate means and said navigation pin means so as to enable higher rotation of said moving contact means with less rotation of said latch link profile means;
wherein said reset roller pin means are operatively connected to said latch link profile means so as to reduce reset force;
wherein said spring pin means are operatively inserted in the fork link profile means in a manner that a plurality of spring means are operatively connected between said spring pin means and said floating pin means.

2. The mechanism as claimed in claim 1, further comprising a latch bracket means adapted to lock and/or unlock said latch link profile means.

3. The mechanism as claimed in claim 1, further comprising a trip plate means adapted to lock and/or unlock said latch bracket means.

4. The mechanism as claimed in claim 1, further comprising a knob means operatively connected to said fork link profile means.

5. The mechanism as claimed in claim 1, wherein said bend portion of the latch link profile means is operatively located on one side of said latch link profile means.

6. The mechanism as claimed in claim 1, wherein said cam profile of the fork link profile means is operatively located on end portions of side limbs of said fork link profile means

7. The mechanism as claimed in claim 1, wherein said navigation pin means are operatively connected to said upper link means.

8. (canceled)
